(19) United States
(12) Patent Application Publication
(10) Pub. No.: US 2022/0080968 A1
(43) Pub. Date: Mar. 17, 2022

(54) ADAPTIVE CRUISE CONTROL

(71) Applicant: Ford Global Technologies, LLC, Dearborn, MI (US)

(72) Inventors: Di Zhu, Canton, MI (US); Ben A. Tabatowski-Bush, Ann Arbor, MI (US); William David Treharne, Ypsilanti, MI (US)

(73) Assignee: Ford Global Technologies, LLC, Dearborn, MI (US)

(21) Appl. No.: 17/021,088

(22) Filed: Sep. 15, 2020

(51) Int. Cl. B60W 30/16; B60W 30/18; B60W 50/14; G06N 20/00; G06N 5/04

(52) U.S. Cl. CPC B60W 30/16; B60W 30/18163; B60W 50/14; B60W 2050/146; G06N 5/04; B60W 2520/00; G06N 20/00

(57) ABSTRACT

A first fuel consumption value is determined for operating a host vehicle in a first lane on a road surface. A second fuel consumption value is predicted for operating the host vehicle in a second lane on the road surface based on acceleration data for a target vehicle operating in the second lane. A request to move the host vehicle from the first lane to the second lane is transmitted to the target vehicle based on the predicted second fuel consumption value being greater than the first fuel consumption value. After receiving an acknowledgement from the target vehicle, the host vehicle is operated from the first lane to the second lane.

### BACKGROUND

A vehicle can be equipped with electronic and electro-mechanical components, e.g., computing devices, networks, sensors and controllers, etc. A vehicle computer can acquire data regarding the vehicle's environment and can operate the vehicle or at least some components thereof based on the data. Vehicle sensors can provide data concerning routes to be traveled and objects to be avoided in the vehicle's environment. For example, a vehicle speed can be set and maintained according to user input and/or based on a speed and/or relative position of a reference vehicle, typically an immediately preceding vehicle.

### BRIEF DESCRIPTION OF THE DRAWINGS

FIG. 1 is a block diagram illustrating an example vehicle control system for a vehicle.

FIGS. 2A-2B are diagrams illustrating operating a host vehicle and a target vehicle according to the system of FIG. 1.

FIG. 3 is an example diagram of a deep neural network.

FIG. 4 is a flowchart of an example process for operating the host vehicle.

FIG. 5 is a flowchart of an example process for operating the target vehicle.

FIG. 6 is a flowchart of another example process for operating the host vehicle.

FIG. 7 is a flowchart of another example process for operating the target vehicle.

### DETAILED DESCRIPTION

A system includes a computer including a processor and a memory, the memory storing instructions executable by the processor to determine a first fuel consumption value for operating a host vehicle in a first lane on a road surface. The instructions further include instructions to predict a second fuel consumption value for operating the host vehicle in a second lane on the road surface based on acceleration data for a target vehicle operating in the second lane. The instructions further include instructions to transmit, to the target vehicle, a request to move the host vehicle from the first lane into the second lane based on the predicted second fuel consumption value being greater than the first fuel consumption value. The instructions further include instructions to, after receiving an acknowledgement from the target vehicle, operate the host vehicle from the first lane to the second lane.

The instructions can further include instructions to determine the first fuel consumption value based on acceleration data for a lead vehicle operating in the first lane in front of the host vehicle.

The instructions can further include instructions to, upon receiving the acknowledgement, display a message in the host vehicle requesting a user input to authorize operating the host vehicle from the first lane to the second lane.

The instructions can further include instructions to operate the host vehicle from the first lane to the second lane based on receiving the user input in the host vehicle authorizing to operate the host vehicle from the first lane to the second lane.

The instructions can further include instructions to actuate a host vehicle component to output a signal indicating the request.

The instructions can further include instructions to detect the acknowledgement based on host vehicle sensor data.

The instructions can further include instructions to, upon operating the host vehicle in the second lane, provide a number of tokens to a second computer of the target vehicle based on a transfer rule.

The instructions can further include instructions to determine the transfer rule based on at least one of the request or the acknowledgement.

The instructions can further include instructions to, upon determining the transfer rule, operate the host vehicle from the first lane to the second lane based on receiving a user input in the host vehicle authorizing the transfer rule.

The first computer may be included on the host vehicle. The system can include a second computer on the target vehicle. The second computer can include a second processor and a second memory, the second memory storing instructions executable by the second processor to, after providing the acknowledgement, operate the target vehicle to maintain a distance between the host vehicle and the target vehicle greater than a distance threshold.

The instructions can further include instructions to actuate a target vehicle component to output a signal indicating the acknowledgement.

The instructions can further include instructions to detect the request based on target vehicle sensor data.

The instructions can further include instructions to input acceleration data for the target vehicle into a machine learning program that predicts the second fuel consumption value for operating the host vehicle in the second lane.

The instructions can further include instructions to identify the target vehicle based on an acceleration of the target vehicle being above a threshold acceleration for a time period.

The instructions can further include instructions to identify the target vehicle based further on a speed of the target vehicle being equal to or greater than a speed of the host vehicle for the time period.

A method includes determining a first fuel consumption value for operating a host vehicle in a first lane on a road surface. The method further includes predicting a second fuel consumption value for operating the host vehicle in a second lane on the road surface based on acceleration data for a target vehicle operating in the second lane. The method further includes transmitting, to the target vehicle, a request to move the host vehicle from the first lane into the second lane based on the predicted second fuel consumption value being greater than the first fuel consumption value. The method further includes, after receiving an acknowledgement from the target vehicle, operating the host vehicle from the first lane to the second lane.

The method can further include identifying the target vehicle based on an acceleration of the target vehicle being above a threshold acceleration for a time period.

The method can further include identifying the target vehicle based further on a speed of the target vehicle being equal to or greater than a speed of the host vehicle for the time period.

The method can further include, upon receiving the acknowledgement, displaying a message in the host vehicle requesting a user input to authorize operating the host vehicle from the first lane to the second lane.

The method can further include operating the host vehicle from the first lane to the second lane based on receiving the user input in the host vehicle authorizing to operate the host vehicle from the first lane to the second lane.

Further disclosed herein is a computing device programmed to execute any of the above method steps. Yet further disclosed herein is a computer program product, including a computer readable medium storing instructions executable by a computer processor, to execute an of the above method steps.

A host vehicle can include an adaptive cruise control system to control a speed of the host vehicle, including by taking into account a lane of travel likely to result in more efficient fuel consumption. In an adaptive cruise control system, a vehicle computer can maintain or adjust the speed of the host vehicle in a first lane based on a speed and relative position of a lead vehicle in front of the host vehicle. For example, the vehicle computer can actuate a braking component to reduce the speed of the host vehicle when the lead vehicle decelerates and/or is within a specified distance of the host vehicle. As another example, the vehicle computer can actuate a propulsion component to increase the speed of the host vehicle when the lead vehicle accelerates and/or is outside of the specified distance of the host vehicle. However, adjusting the speed of the host vehicle in response to changes in the lead vehicle operation, i.e., acceleration or deceleration of the lead vehicle, can result in aggressive deceleration, e.g., to avoid impacting the lead vehicle, and/or aggressive acceleration, e.g., to increase the host vehicle speed to a pre-set speed, which can reduce a fuel consumption value of the host vehicle.

Advantageously and as described herein, the vehicle computer can predict a fuel consumption value for operating the host vehicle in a second lane. By predicting the fuel consumption value for operating the host vehicle in the second lane, the vehicle computer can move the host vehicle to a second lane when the predicted fuel consumption value for operating the host vehicle in the second lane is greater than the fuel consumption value for operating the host vehicle in the first lane, which can improve fuel consumption for operating the host vehicle. Additionally, the vehicle computer can move the host vehicle to the second lane after receiving an acknowledgment from a target vehicle operating in the second lane, which can reduce the likelihood of the target vehicle aggressively decelerating to avoid impacting the host vehicle, and thus can also improve fuel consumption of the target vehicle.

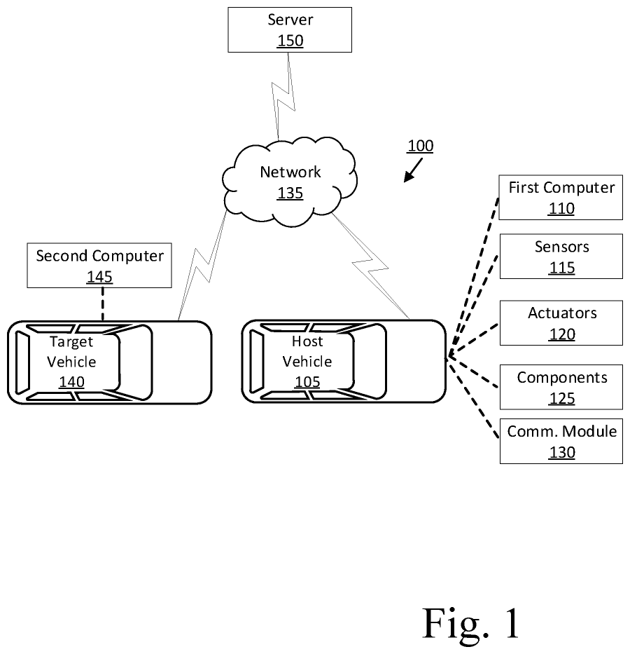

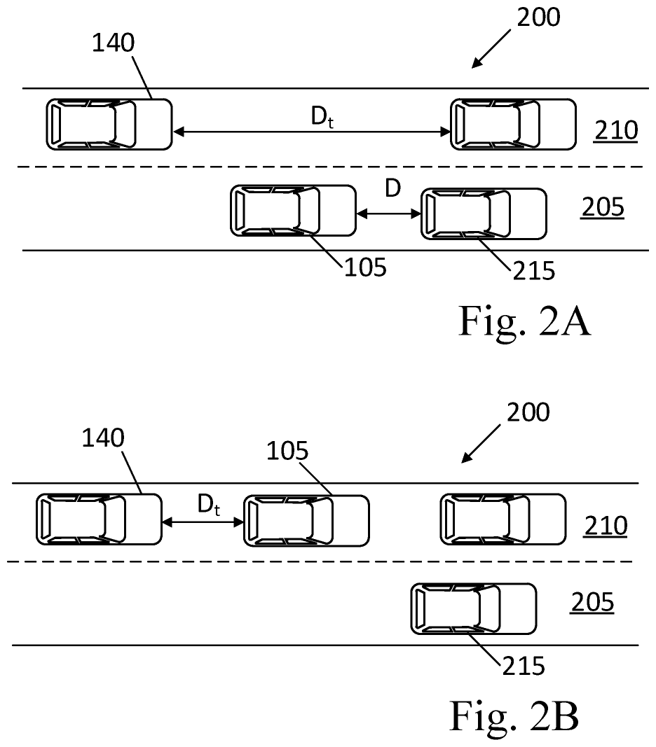

With initial reference to FIGS. 1-2B, an example vehicle control system 100 includes a host vehicle 105. A first computer 110 in the host vehicle 105 receives data from sensors 115. The first computer 110 is programmed to determine a first fuel consumption value for operating the host vehicle 105 in a first lane 205 on a road surface 200. The first computer 110 is further programmed to predict a second fuel consumption value for operating the host vehicle 105 in a second lane 210 on the road surface 200 based on acceleration data for a target vehicle 140 operating in the second lane 210. The first computer 110 is further programmed to transmit, to the target vehicle 140, a request to move the host vehicle 105 from the first lane 205 into the second lane 210 based on the predicted second fuel consumption value being greater than the first fuel consumption value. The first computer 110 is further programmed to, after receiving an acknowledgement from the target vehicle 140, operate the host vehicle 105 from the first lane 205 to the second lane 210.

Turning now to FIG. 1, the host vehicle 105 includes the first computer 110, sensors 115, actuators 120 to actuate various vehicle components 125, and a vehicle communications module 130. The communications module 130 allows the first computer 110 to communicate with a server 150 and/or other vehicles, e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135.

The first computer 110 includes a processor and a memory such as are known. The memory includes one or more forms of computer-readable media, and stores instructions executable by the first computer 110 for performing various operations, including as disclosed herein. The first computer 110 can further include two or more computing devices operating in concert to carry out host vehicle 105 operations including as described herein. Further, the first computer 110 can be a generic computer with a processor and memory as described above and/or may include a dedicated electronic circuit including an ASIC that is manufactured for a particular operation, e.g., an ASIC for processing sensor data and/or communicating the sensor data. In another example, the first computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in the first computer 110.

The first computer 110 may operate the host vehicle 105 in an autonomous, a semi-autonomous mode, or a non-autonomous (or manual) mode. For purposes of this disclosure, an autonomous mode is defined as one in which each of host vehicle 105 propulsion, braking, and steering are controlled by the first computer 110; in a semi-autonomous mode the first computer 110 controls one or two of host vehicle 105 propulsion, braking, and steering; in a non-autonomous mode a human operator controls each of host vehicle 105 propulsion, braking, and steering.

The first computer 110 may include programming to operate one or more of host vehicle 105 brakes, propulsion (e.g., control of acceleration in the host vehicle 105 by controlling one or more of an internal combustion engine, electric motor, hybrid engine, etc.), steering, transmission, climate control, interior and/or exterior lights, horn, doors, etc., as well as to determine whether and when the first computer 110, as opposed to a human operator, is to control such operations.

The first computer 110 may include or be communicatively coupled to, e.g., via a vehicle communications network such as a communications bus as described further below, more than one processor, e.g., included in electronic controller units (ECUs) or the like included in the host vehicle 105 for monitoring and/or controlling various vehicle components 125, e.g., a transmission controller, a brake controller, a steering controller, etc. The first computer 110 is generally arranged for communications on a vehicle communication network that can include a bus in the host vehicle 105 such as a controller area network (CAN) or the like, and/or other wired and/or wireless mechanisms.

Via the host vehicle 105 network, the first computer 110 may transmit messages to various devices in the host vehicle 105 and/or receive messages (e.g., CAN messages) from the various devices, e.g., sensors 115, an actuator 120, ECUs, etc. Alternatively, or additionally, in cases where the first computer 110 actually comprises a plurality of devices, the vehicle communication network may be used for communications between devices represented as the first computer 110 in this disclosure. Further, as mentioned below, various controllers and/or sensors 115 may provide data to the first computer 110 via the vehicle communication network.

Host vehicle 105 sensors 115 may include a variety of devices such as are known to provide data to the first computer 110. For example, the sensors 115 may include Light Detection And Ranging (LIDAR) sensor(s) 115, etc., disposed on a top of the host vehicle 105, behind a host vehicle 105 front windshield, around the host vehicle 105, etc., that provide relative locations, sizes, and shapes of objects surrounding the host vehicle 105. As another example, one or more radar sensors 115 fixed to host vehicle 105 bumpers may provide data to provide locations of the objects, second vehicles, etc., relative to the location of the host vehicle 105. The sensors 115 may further alternatively or additionally, for example, include camera sensor(s) 115, e.g. front view, side view, etc., providing images from an area surrounding the host vehicle 105. In the context of this disclosure, an object is a physical, i.e., material, item that has mass and that can be represented by physical phenomena (e.g., light or other electromagnetic waves, or sound, etc.) detectable by sensors 115. Thus, the host vehicle 105 and the target vehicle 140, as well as other items including as discussed below, fall within the definition of “object” herein.

The first computer 110 is programmed to receive data from one or more sensors 115 substantially continuously, periodically, and/or when instructed by a server 150, etc. The data may, for example, include a location of the host vehicle 105. Location data specifies a point or points on a ground surface and may be in a known form, e.g., geo-coordinates such as latitude and longitude coordinates obtained via a navigation system, as is known, that uses the Global Positioning System (GPS). Additionally, or alternatively, the data can include a location of an object, e.g., a vehicle, a sign, a tree, etc., relative to the host vehicle 105. As one example, the data may be image data of the environment around the host vehicle 105. In such an example, the image data may include one or more objects and/or markings, e.g., lane markings, on or along the current road 200. Image data herein means digital image data, e.g., comprising pixels with intensity and color values, that can be acquired by camera sensors 115. The sensors 115 can be mounted to any suitable location in or on the host vehicle 105, e.g., on a host vehicle 105 bumper, on a host vehicle 105 roof, etc., to collect images of the environment around the host vehicle 105.

The host vehicle 105 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of a host vehicle 105.

In the context of the present disclosure, a vehicle component 125 is one or more hardware components adapted to perform a mechanical or electro-mechanical function or operation—such as moving the host vehicle 105, slowing or stopping the host vehicle 105, steering the host vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component 125 (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

In addition, the first computer 110 may be configured for communicating via a vehicle-to-vehicle communication module 130 or interface with devices outside of the host vehicle 105, e.g., through a vehicle-to-vehicle (V2V) or vehicle-to-infrastructure (V2X) wireless communications (cellular and/or DSRC, etc.) to another vehicle, and/or to a server 150 (typically via direct radio frequency communications). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), and/or wide area networks (WAN), including the Internet, providing data communication services.

The network 135 represents one or more mechanisms by which a first computer 110 may communicate with remote computing devices, e.g., the server 150, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The target vehicle 140 may include a second computer 145. The second computer 145 includes a second processor and a second memory such as are known. The second memory includes one or more forms of computer-readable media, and stores instructions executable by the second computer 145 for performing various operations, including as disclosed herein.

Additionally, the target vehicle 140 may include sensors, actuators to actuate various vehicle components, and a vehicle communications module. The sensors, actuators to actuate various vehicle components, and the vehicle communications module typically have features in common with the sensors 115, actuators 120 to actuate various host vehicle components 125, and the vehicle communications module 130, and therefore will not be described further to avoid redundancy.

The server 150 can be a conventional computing device, i.e., including one or more processors and one or more memories, programmed to provide operations such as disclosed herein. Further, the server 150 can be accessed via the network 135, e.g., the Internet, a cellular network, and/or or some other wide area network.

Turning now to FIGS. 2A and 2B, FIG. 2A is a diagram illustrating a host vehicle 105 operating in an first lane 205 of an example road 200, and FIG. 2B is a diagram illustrating the host vehicle 105 operating in a second lane 210 of the road 200. A lane is a specified area of the road for vehicle travel. A road in the present context is an area of ground surface that includes any surface provided for land vehicle travel. A lane of a road is an area defined along a length of a road, typically having a width to accommodate only one vehicle, i.e., such that multiple vehicles can travel in a lane one in front of the other, but not abreast of, i.e., laterally adjacent, one another.

The first computer 110 is programmed to identify a first lane 205, i.e., a lane in which the host vehicle 105 is operating, and one or more second lanes 210, i.e., a lane in which the host vehicle 105 is not operating, on the road 200. For example, the first computer 110 can receive map data and/or location data, e.g., GPS data, from a remote server computer 150 specifying the first lane 205 and the second lane(s) 210. As another example, the first computer 110 may identify the first lane 205 and the second lane(s) 210 based on sensor 115 data. That is, the first computer 110 can be programmed to receive sensor 115 data, typically, image data, from sensors 115 and to implement various image processing techniques to identify the first lane 205 and the second lane(s) 210. For example, lanes can be indicated by markings, e.g., painted lines on the road 200, and image recognition techniques, such as are known, can be executed by the first computer 110 to identify the first lane 205. For example, the first computer 110 can identify solid lane markings on opposite sides of the host vehicle 105. The first computer 110 can then identify the first lane 205 of host vehicle 105 operation based on a number of groups of dashed lane markings between each side of the host vehicle 105 and the respective solid lane marking. A solid lane marking is a marking extending continuously, i.e., is unbroken, along a length of a road and defining at least one boundary of a lane. A group of dashed lane markings includes a plurality of markings spaced from each other along a length of a road and defining at least one boundary of a lane. Additionally, the first computer 110 can determine the second lane(s) 210 on each side of the first lane 205 based on the number of groups of dashed lane markings on each side of the host vehicle 105 (e.g., a number of second lanes is equal to the number of groups of dashed lane markings).

While operating in the first lane 205, the first computer 110 can receive sensor 115 data, e.g., image data, of the environment around the host vehicle 105 in the first lane 205. The image data can include one or more vehicles traveling on the road 200 around the host vehicle 105. For example, object classification or identification techniques, can be used, e.g., in the first computer 110 based on lidar sensor 115, camera sensor 115, etc., data to identify a type of object, e.g., a vehicle, a bicycle, a drone, etc., as well as physical features of objects.

Various techniques such as are known may be used to interpret sensor 115 data and/or to classify objects based on sensor 115 data. For example, camera and/or lidar image data can be provided to a classifier that comprises programming to utilize one or more conventional image classification techniques. For example, the classifier can use a machine learning technique in which data known to represent various objects, is provided to a machine learning program for training the classifier. Once trained, the classifier can accept as input vehicle sensor 115 data, e.g., an image, and then provide as output, for each of one or more respective regions of interest in the image, an identification and/or a classification (i.e., movable or non-movable) of one or more objects or an indication that no object is present in the respective region of interest. Further, a coordinate system (e.g., polar or cartesian) applied to an area proximate to the host vehicle 105 can be used to specify locations and/or areas (e.g., according to the host vehicle 105 coordinate system, translated to global latitude and longitude geo-coordinates, etc.) of objects identified from sensor 115 data. Yet further, the first computer 110 could employ various techniques for fusing (i.e., incorporating into a common coordinate system or frame of reference) data from different sensors 115 and/or types of sensors 115, e.g., lidar, radar, and/or optical camera data.

Upon identifying the object as a vehicle, the first computer 110 is programmed to identify the vehicle as a target vehicle 140 or a lead vehicle 215 based on a longitudinal position of the vehicle and a lane of vehicle operation. A lead vehicle 215 is a vehicle operating in the first lane 205 and forward of the host vehicle 105. A target vehicle 140 is a vehicle operating in a second lane 210 and rearward of or next to the host vehicle 105. For example, the classifier can be further trained with data known to represent various longitudinal positions and lanes of operation. Thus, in addition to identifying the object as a vehicle, the classifier can output an identification of a target vehicle 140 or a lead vehicle 215 based on the longitudinal position and the lane of vehicle operation. Once trained, the classifier can accept as input host vehicle sensor 115 data, e.g., an image, and then provide as output for each of one or more respective regions of interest in the image, an identification of a target vehicle 140 based on the vehicle being rearward of or next to the host vehicle 105 and operating in a second lane 210, or that no target vehicle 140 is present in the respective region of interest based on detecting no vehicle rearward of or next to the host vehicle 105 and operating in a second lane 210. Additionally, once trained, the classifier can accept as input host vehicle sensor 115 data, e.g., an image, and then provide as output for each of one or more respective regions of interest in the image, an identification of a lead vehicle 215 based on the vehicle being forward of the host vehicle 105 and operating in a first lane 205, or that no lead vehicle 215 is present in the respective region of interest based on detecting no vehicle forward of the host vehicle 105 and operating in the first lane 205.

The first computer 110 may determine the longitudinal position of a detected vehicle 140, 215 based on sensor 115 data. For example, the first computer 110 may determine a detected vehicle 140, 215 is forward of the host vehicle 105 based on image data from a forward-facing camera. Forward of the host vehicle 105 means that a rearmost point of the identified vehicle 140, 215 is forward of a frontmost point of the host vehicle 105. As another example, the first computer 110 may determine the detected vehicle 140, 215 is rearward of the host vehicle 105 based on image data from a rear-facing camera. Rearward of the host vehicle 105 means that a frontmost point of the identified vehicle 140, 215 is rearward of a rearmost point of the host vehicle 105. As yet another example, the first computer 110 may determine the detected vehicle 140, 215 is next to the host vehicle 105 based on image data from a side-facing camera. Next to the host vehicle 105 means any point of the identified vehicle 140, 215 is between the frontmost point and the rearmost point of the host vehicle 10.

The first computer 110 is programmed to determine a lane of operation for an identified vehicle 140, 215. For example, the first computer 110 may determine the lane of operation of the identified vehicle 140, 215 by using image data to identify lane markings on each side of the identified vehicle 140, 215, e.g., according to image processing techniques, as discussed above. In such an example, the first computer 110 can determine the identified vehicle 140, 215 is in the first lane 205 when the number of lanes on each side of the identified vehicle 140, 215 is the same as the number of lanes on the respective side of the host vehicle 105. As another example, the first computer 110 may receive location data from the identified vehicle 140, 215, e.g., via V2V communications, specifying the lane of operation of the identified vehicle 140, 215.

Additionally, or alternatively, the first computer 110 can identify the vehicle as a target vehicle 140 based on a speed of the vehicle being greater than or equal to a speed of the host vehicle 105 for a time period. For example, the first computer 110 can determine a speed of the vehicle (as discussed below) and a speed of the host vehicle 105 (e.g., based on sensor 115 data, such as wheel speed sensor data) at multiple instances. The first computer 110 can then determine the average speed of the vehicle by summing the speeds of the detected vehicle 140, 215 and dividing by the number of instances, and can determine the average speed of the host vehicle 105 by summing the speeds of the host vehicle 105 and dividing by the number of instances. The first computer 110 can then compare the average speed of the vehicle to the average speed of the host vehicle 105. When the average speed of the vehicle is greater than or equal to the average speed of the host vehicle 105, the first computer 110 can identify the vehicle as a target vehicle 140. The time period may, for example, be a predetermined time period, e.g., 30 seconds, 2 minutes, 5 minutes, etc.

The first computer 110 may be programmed to determine a speed of the vehicle based on sensor 115 data. The first computer 110 may determine the speed of the vehicle relative to the host vehicle 105 by determining a change in distance between the vehicle and the host vehicle 105 over time. For example, the first computer 110 determine the speed of the vehicle relative to the host vehicle 105 with the formula ΔD/ΔT, where ΔD is a difference between a pair of distances from the host vehicle 105 to the vehicle (as discussed below) taken at different times and ΔT is an amount of time between when the pair of distances was determined. Where ΔT may be a portion, i.e., some but less than all, of the time period. For example, the difference between the pair of distances ΔD may be determined by subtracting the distance determined earlier in time from the distance determined later in time. In such an example, a positive value indicates that the vehicle is traveling slower than the host vehicle 105, and a negative value indicates that the vehicle is traveling faster than the host vehicle 105. As another example, the first computer 110 may receive the speed of the vehicle, e.g., via V2V communications.

Additionally, or alternatively, the first computer 110 can identify the vehicle as a target vehicle 140 based on an average acceleration of the vehicle being less than or equal to a threshold acceleration for the time period. The threshold acceleration is an expected acceleration for a vehicle being operated by a computer on a road and in the absence of a lead vehicle 215. The threshold acceleration may be determined empirically based on, e.g., a maximum average acceleration to maintain a speed of the vehicle on the road (e.g., based on a grade, i.e., slope, of the road, material of the road, environmental factors, such as wind and precipitation, etc.). For example, the first computer 110 can determine an acceleration of the vehicle at multiple instances. The first computer 110 can then determine the average acceleration of the vehicle by summing the accelerations of the vehicle and dividing by the number of instances. The first computer 110 can then compare the average acceleration of the vehicle to the threshold acceleration. When the average acceleration of the vehicle is less than or equal to the threshold acceleration for the time period, the first computer 110 can identify the vehicle as a target vehicle 140.

The first computer 110 may be programmed to determine an acceleration of the vehicle based on sensor 115 data. The first computer 110 may determine the acceleration of the vehicle relative to the host vehicle 105 by determining a change in speed of the vehicle over time. For example, the first computer 110 determine the acceleration of the vehicle relative to the host vehicle 105 with the formula ΔS/ΔT, where ΔS is a difference between a pair of speeds of the vehicle taken at different times and ΔT is an amount of time between when the pair of distances was determined. For example, the difference between the pair of speeds ΔS may be determined by subtracting the speed determined earlier in time from the speed determined later in time. In such an example, a positive value indicates that the vehicle is decelerating relative to the host vehicle 105, and a negative value indicates that the vehicle is accelerating relative to the host vehicle 105. As another example, the first computer 110 may receive the acceleration of the vehicle, e.g., via V2V communications.

Additionally, or alternatively, the first computer 110 can identify the vehicle as a target vehicle 140 or a lead vehicle 215 based on clustered data. For example, the first computer 110 can be programmed to perform data clustering on data obtained for the vehicle. Data clustering means assigning n datum to k clusters such that each datum is assigned to a cluster based on proximity to a mean. That is, a datum is assigned to the cluster with the nearest mean. The clustering process is described herein with respect to a datum from each vehicle included in the clustering process. The described cluster process can also apply to sets of datum specifying values for two or more operating parameters respectively for each vehicle. For example, clustering can be performed based on a set of data respectively from each vehicle specifying an acceleration and/or a speed. One example of a clustering method is k-means.

In an example, a set of n data includes (x₁, x₂, . . . , xₙ) where each datum is a d-dimensional real vector. The k-means method seeks to cluster the n data into k (k≤n) sets S={s₁, s₂, . . . , sₖ} to minimize the variance within each cluster, where the variance is the within-cluster sum of squares. This is expressed in equation 1:

$$\frac{arg min}{S} {{\sum }^{k}}_{i = 1} {\sum }_{x ∈ {s}_{i}} {‖ x - {u}_{i} ‖}^{2} = \frac{arg min}{S} {{\sum }^{k}}_{i = 1} \vert {S}_{i} \vert Var {S}_{i} \qquad Eq . 1$$

where u₁ is the mean of the data in Sᵢ. This is equivalent to minimizing the pairwise squared deviations of points in the same cluster and can be expressed as:

$$\frac{arg min}{S} {{\sum }^{k}}_{i = 1} \frac{1}{2 \vert {S}_{i} \vert} {\sum }_{x , y ∈ {S}_{i}} {‖ x - y ‖}^{2} .$$

The equivalence can be deduced from identity:

Σ_{x∈S}_{ᵢ}∥x−uᵢ∥²=Σ_{x≠y∈S}_{ᵢ}(x−uᵢ)(uᵢ−y).

An example algorithm for implementing k-means clustering uses a two-step iterative process. In a first step, which can be referred to as the assignment step, each datum is assigned to the cluster that has the least squared distance. This can be expressed according to equation 2, below:

Sᵢ^{(t)}={xₚ:∥xₚ−mᵢ^{(t)}∥²≤∥xₚ−mⱼ^{(t)}∥²∀ⱼ,1≤j≤l}, Eq. 2

where each xₚ is assigned to exactly one S^{(t)}, even if xₚ could be assigned to two or more S^{(t)}.

The second step is an update step, wherein each of the means mᵢ^{(t)} is recalculated to be the centroids of the clusters k identified according to equation 3, shown below:

$${m}_{i}^{( t + 1 )} = \frac{1}{\vert {S}_{i}^{( t )} \vert} \cdot {\sum }_{{x}_{j} ∈ {S}_{i}^{( t )}} {x}_{j} \qquad Eq . 3$$

After updating the values to each of the means, the process repeats the assignment step according to equation 2, above. The process continues to iterate between the assignment step and the update step until none of the datum xₚ are reassigned during the assignment step.

To apply k-means clustering, initial values of the k-means are selected. One possibility for selecting initial values for the k-means is to select k data from the initial data independent of the values of the data. For example, in the case that k=2, the first and last datum, the second and fourth datum, or any other two data within the collected data could be selected as the initial k-means. In other examples, initial values for the k-means may be made based on expected values for each mean, e.g., determined empirically based on an average acceleration for a vehicle operated by a computer on a current road and an average acceleration for a vehicle operated by a user on the current road. For example, at a given point in a lane of a road, there could be two expected accelerations; acceleration (i.e., an absolute value of acceleration) or no acceleration. A first mean could be selected to be a value greater than the threshold acceleration, and a second mean could be selected to be a value less than or equal the threshold acceleration, e.g., zero.

The first computer 110 can cluster data for the vehicle based on acceleration data of the vehicle. In an example, the number of clusters k=2. That is, data will be clustered into two sets. The first computer 110 can, in the assignment step, calculate that acceleration data for the vehicle is closer to one mean than to the other mean. In the update step, the first computer 110 can calculate, based on equation 3 above, the one mean to be a location central to the acceleration data of the vehicle where the variance (sum of the squares of the differences of the data from the mean) is minimized.

In this example, in a second iteration, none of the datum will be reassigned to a different set. Accordingly, the k-means clustering process will end. In more complex situations, one or more data may be reassigned to a different data set after the means were updated; in such examples, the process iterates until no data are assigned to different sets in the assignment step.

To identify the vehicle as a target vehicle 140 or a lead vehicle 215 based on cluster data, the first computer 110 can, for example, identify a centroid for the majority cluster for each set of clustered data. A centroid is the mean position of all the data in the set of clustered data in all coordinate directions. A set of clustered data is defined herein as a set of data to which the first computer 110 applied a clustering algorithm. For example, a set of clustered data may be the acceleration data for vehicle. The majority cluster is the cluster which includes the most data after completion of the clustering algorithm.

The first computer 110 may then compare the centroid of the majority cluster to the threshold acceleration. The first computer 110 may identify the vehicle as a lead vehicle 215 when the centroid of the majority cluster is greater than the threshold acceleration. The first computer 110 may identify the vehicle as a target vehicle 140 when the centroid of the majority cluster is less than or equal to the threshold acceleration.

The first computer 110 may determine a distance from the host vehicle 105 to the identified vehicle 140, 215 based on sensor 115 data. For example, a lidar sensor 115 can emit a light beam and receive a reflected light beam reflected off an object, e.g., the identified vehicle 140, 215. The first computer 110 can measure a time elapsed from emitting the light beam to receiving the reflected light beam. Based on the time elapsed and the speed of light, the first computer 110 can determine the distance between the host vehicle 105 and the identified vehicle 140, 215.

The first computer 110 may be programmed to maintain a distance D from a lead vehicle 215 equal to or greater than a distance threshold. That is, the first computer 110 may actuate one or more host vehicle components 125 to control the host vehicle 105, e.g., apply brakes, propel the host vehicle 105, etc., to maintain the distance D from the lead vehicle 215 of at least the distance threshold. That is, the first computer 110 may be programmed to adjust the speed and/or acceleration of the host vehicle 105 based on the speed and/or acceleration of the lead vehicle 215 while operating the host vehicle 105 in the first lane 205. The distance threshold may be determined empirically, e.g., based on a minimum distance at which the first computer 110 can control the host vehicle 105 to prevent the host vehicle 105 from impacting the lead vehicle 215 (e.g., based on a speed of the host vehicle 105, a speed of the lead vehicle 215, etc.).

The first computer 110 can determine a first fuel consumption value for operating the host vehicle 105 in the first lane 205. A fuel consumption value is an amount of fuel consumed per distance traveled, e.g., miles per gallon (mpg). The first computer 110 can determine the first fuel consumption value by measuring, e.g., via sensor 115 data, an amount of fuel consumed while operating in the first lane 205 and dividing the amount of fuel consumed by the distance traveled in the first lane 205 while measuring the fuel consumption. In the case that the host vehicle 105 is propelled by an internal combustion engine, an amount of fuel is a volume of fluid fuel, e.g., gasoline. In the case that the host vehicle 105 is propelled by an electric engine, an amount of fuel is an amount of electric charge spent by the battery. In such an example, the first computer 110 can use known electric discharge conversion rates to equivalent fluid fuel volumes to determine the fuel consumption, e.g., 33.7 kWh of electricity=1 gallon of gasoline, etc.

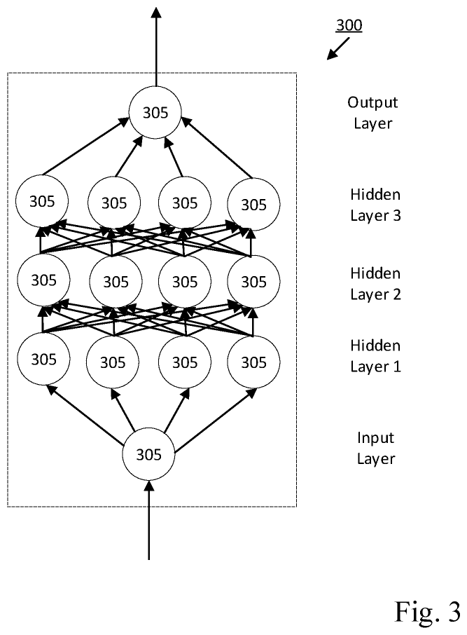

As another example, the first computer 110 can input acceleration data and/or speed data for a lead vehicle 215 into a neural network, such as a Deep Neural Network (DNN) (see FIG. 3), that can be trained to accept acceleration data and/or speed data for the lead vehicle 215 as input and generate an output identifying the first fuel consumption value for operating the host vehicle 105 behind the lead vehicle 215, i.e., in a first lane 205.

The first computer 110 can predict a second fuel consumption value for operating the host vehicle 105 in the second lane 210. For example, the first computer 110 can input acceleration data and/or speed data for a target vehicle 140 into the neural network, such as a DNN (see FIG. 3), that can be trained to accept acceleration data and/or speed data for the target vehicle 140 as input and generate an output identifying the second fuel consumption value for operating the host vehicle 105 in a second lane 210.

The first computer 110 can then compare the first fuel consumption value to the second fuel consumption value. When the second fuel consumption value is greater than the first fuel consumption value, the first computer 110 can be programmed to initiate a lane change. When the second fuel consumption value is less than or equal to the first fuel consumption value, the first computer 110 can be programmed to maintain the host vehicle 105 in the first lane 205. A second fuel consumption value is “greater” than a first fuel consumption value when the second fuel consumption value is larger than the first fuel consumption value, e.g., 20 mpg is greater than 18 mpg. Similarly, the second fuel consumption is “less” than the first fuel consumption value when the second fuel consumption is smaller than the first fuel consumption value, e.g., 18 mpg is lower than 20 mpg and 18 mpg is below 20 mpg.

Upon initiating a lane change for a host vehicle 105, the first computer 110 can be programmed to provide, to a target vehicle 140, a request to move the host vehicle 105 from the first lane 205 to a second lane 210. For example, the first computer 110 can transmit the request to the target vehicle 140, e.g., via V2V communications. As another example, the first computer 110 can be programmed to actuate one or more host vehicle components 125 to output a signal indicating the request. The first computer 110 can store, e.g., in a memory, a look-up table or the like that correlates actuation of host vehicle components 125 to a request. For example, the first computer 110 can activate a turn signal on the same side of the host vehicle 105 as the second lane 210. As another example, the first computer 110 can actuate one or more vehicle components 125 to move the host vehicle 105 towards a lane marking that partially defines both the first lane 205 and the second lane 210, etc.

The first computer 110 may be programmed to detect an acknowledgement from the target vehicle 140. For example, the first computer 110 can receive the acknowledgement from the second computer 145, e.g., via V2V communications. As another example, the first computer 110 can receive and analyze host vehicle sensor 115 data, e.g., image data, lidar data, etc., to detect the acknowledgement. In such an example, the first computer 110 can store, e.g., in a memory, a look-up table or the like that correlates sensor 115 data to an acknowledgement. For example, the first computer 110 can detect activation of one or more target vehicle 140 components, as discussed below, via the host vehicle sensor 115 data, e.g., by using image processing techniques. The first computer 110 can then determine the acknowledgement based on the look-up table and the sensor 115 data.

Upon receiving the acknowledgement, the first computer 110 can display a message in the host vehicle 105 requesting a user input to authorize operating the host vehicle 105 from the first lane 205 to the second lane 210. For example, the first computer 110 can actuate a human-machine interface (HMI) that includes output devices such as displays, e.g., a touchscreen display, that outputs the message to a user. The HMI is coupled to the vehicle communications network and can send and/or receive messages to/from the first computer 110 and other vehicle sub-systems.

The HMI further includes user input devices, such as knobs, buttons, switches, pedals, levers, touchscreens, etc. The user input devices may include sensors 115 to detect user inputs and provide user input data to the first computer 110. That is, the first computer 110 may be programmed to receive user input from the HMI. The user may provide the user input via the HMI, e.g., by pressing a virtual button on a touchscreen display. For example, a touchscreen display included in the HMI may include sensors 115 to detect that a user pressed a virtual button on the touchscreen display to, e.g., to authorize moving the host vehicle 105 from the first lane 205 to the second lane 210, to authorize a transfer rule (as discussed below), etc., which input can be received in the first computer 110 and used to determine the selection of the user input.

The first computer 110 can be programmed to move the host vehicle 105 from the first lane 205 to a second lane 210, e.g., upon receiving the user input. For example, the first computer 110 can actuate one or more host vehicle components 125 to move the host vehicle 105 from the first lane 205 to the second lane 210, e.g., in front of the target vehicle 140. In such an example, the second computer 145 can control the target vehicle 140 to allow the host vehicle 105 to move into the second lane 210, as discussed further below.

The first computer 110 can be programmed to provide a confirmation record to the second computer 145. For example, the first computer 110 can transmit the confirmation record to the second computer 145, e.g., via V2V communications. A confirmation record is a set of data that specifies that the target vehicle 140 will accommodate the host vehicle 105 to operate in the second lane 210, i.e., will operate in a manner to allow the host vehicle 105 to operate in the second lane 210. The confirmation record may specify a number of tokens, i.e., a transfer rule (as discussed below), to be transferred from the first computer 110 to the second computer 145. Additionally, or alternatively, the confirmation record may specify updates to target vehicle 140 operation, e.g., a reduction in target vehicle 140 speed. In such a situation, the first computer 110 can be programmed to move the host vehicle 105 to the second lane 210 after receiving, e.g., via V2V communications, a validated confirmation record from the second computer 145.

The first computer 110 may be programmed to transmit tokens to and/or receive tokens from one or more other computers 145, 150. The first computer 110 may, for example, store tokens in a memory of the first computer 110. For example, upon operating the host vehicle 105 in the second lane 210, the first computer 110 may be programmed to transfer tokens to the target vehicle 140. In the present context, a “token” is data that represents a number of units of an object and is transferrable. The unit can be, for example, a unit of currency money, e.g., 0.01 cents, 0.1 cents, 1 cent, a unit of virtual currency (or faction thereof), etc., an amount of an object, e.g., size or weight, of a raw material object, e.g., 1 gram of gold or silver, 1 foot of lumber, etc. For example, the first computer 110 can transfer a number of tokens based on a transfer rule. Herein, a “transfer rule” is a specification of a number of tokens (the number can be one or more) required to allow the host vehicle 105 to operate in the second lane 210. That is, the first computer 110 may transfer a number of tokens specified by the transfer rule upon operating the host vehicle 105 in the second lane 210.

The first computer 110 may store the transfer rule, e.g., in a memory. In such an example, the first computer 110 can transmit the transfer rule to the target vehicle 140, e.g., in a same or different transmission as the request, and the target vehicle 140 can authorize the transfer rule, e.g., via the acknowledgement. As another example, the first computer 110 can determine the transfer rule based on the acknowledgement, as discussed further below.

A second computer 145 in a target vehicle 140 may be programmed to detect the request from the host vehicle 105. For example, the second computer 145 can receive the request from the first computer 110, e.g., via V2V communications. As another example, the second computer 145 can receive and analyze target vehicle 140 sensor data to detect the request. In such an example, the second computer 145 can store, e.g., in a memory, a look-up table or the like that correlates sensor 115 data to a request, such as a an activated turn signal, the host vehicle 105 moving toward a lane marking between the first lane 205 and the second lane 210, etc. For example, the second computer 145 can detect activation of one or more host vehicle components 125, e.g., a turn signal, via the target vehicle 140 sensor data, e.g., by using image processing techniques. The second computer 145 can then determine the request based on the look-up table and the sensor 115 data.

Upon detecting the request, the second computer 145 can display a message in the target vehicle 140 requesting a user input to authorize accommodating the host vehicle 105 to move into the second lane 210. For example, the second computer 145 can actuate an HMI. The HMI of the target vehicle 140 typically has features in common with the HMI of the host vehicle 105, and therefore will not be described further to avoid redundancy. The second computer 145 may be programmed to receive user input from the HMI. The user may provide the user input via the HMI, e.g., by pressing a virtual button on a touchscreen display. For example, a touchscreen display included in the HMI may include sensors 115 to detect that a user pressed a virtual button on the touchscreen display to, e.g., to authorize accommodating the host vehicle 105 to move into the second lane 210, which input can be received in the second computer 145 and used to determine the selection of the user input

The second computer 145 may be programmed to provide the acknowledgement. That is, the second computer 145 may respond to the request with the acknowledgement. For example, the second computer 145 can transmit the acknowledgement to the first computer 110, e.g., via V2V communications. Alternatively, the second computer 145 can determine to actuate one or more target vehicle components to output a signal indicating the acknowledgement. The second computer 145 can store, e.g., in a memory, a look-up table or the like that correlates actuation of target vehicle 140 components to an acknowledgement, such as flashing headlamps, reducing the speed of the target vehicle 140, etc. For example, the output signal may be determined based on the longitudinal position of the target vehicle 140 relative to the host vehicle 105. As one example, when the target vehicle 140 is behind the host vehicle 105, the look-up table can instruct the second computer 145 to flash headlamps. As another example, when the target vehicle 140 is alongside the host vehicle 105, the look-up table can instruct the second computer 145 to reduce the speed of the target vehicle 140, e.g., to increase a gap distance between the target vehicle 140 and the host vehicle 105.

The second computer 145 may be programmed to detect the confirmation record from the host vehicle 105. For example, the second computer 145 can receive the confirmation record from the first computer 110, e.g., via V2V communications. The second computer 145 can electronically validate the confirmation record. That is, the second computer 145 can update the confirmation record to include an electronic validation for the user of the target vehicle 140, e.g., based on a user input to the HMI. The second computer 145 can then provide the validated confirmation record to the first computer 110, e.g., via V2V communications.

The second computer 145 may be programmed to maintain a distance Dt from the host vehicle 105 equal to or greater than the distance threshold. That is, the second computer 145 may actuate one or more target vehicle components to control the target vehicle 140, e.g., apply brakes, propel the target vehicle 140, etc., to maintain the gap distance from the host vehicle 105 of at least the distance threshold. The second computer 145 may operate the target vehicle 140 to maintain the distance Dt of at least the distance threshold after transmitting the acknowledgement and/or the confirmation record or as a signal to indicate the acknowledgement.

The second computer 145 may be programmed to transmit tokens to and/or receive tokens from one or more other computers 110, 150. The second computer 145 may, for example, store tokens in a memory of the second computer 145. The second computer 145 may store the transfer rule, e.g., in a memory. In such an example, the second computer 145 can transmit the transfer rule to the first computer 110, e.g., in a same or different transmission as the acknowledgement, and the user input, e.g., via the HMI in the host vehicle 105, can authorize the transfer rule in addition to authorizing to move the host vehicle 105 from the first lane 205 to the second lane 210.

FIG. 3 is a diagram of an example deep neural network (DNN) 300 that can be trained to predict a fuel consumption value for operating the host vehicle 105 in a lane 205, 210 based on acceleration data and/or speed data for an identified vehicle 140, 215 operating in the lane 205, 210. The DNN 300 can be a software program that can be loaded in memory and executed by a processor included in a computer, for example. In an example implementation, the DNN 300 can include, but is not limited to, a convolutional neural network (CNN), R-CNN (Region-based CNN), Fast R-CNN, and Faster R-CNN. The DNN includes multiple nodes, and the nodes are arranged so that the DNN 300 includes an input layer, one or more hidden layers, and an output layer. Each layer of the DNN 300 can include a plurality of nodes 305. While FIG. 3 illustrate three (3) hidden layers, it is understood that the DNN 300 can include additional or fewer hidden layers. The input and output layers may also include more than one (1) node 305.

The nodes 305 are sometimes referred to as artificial neurons 305, because they are designed to emulate biological, e.g., human, neurons. A set of inputs (represented by the arrows) to each neuron 305 are each multiplied by respective weights. The weighted inputs can then be summed in an input function to provide, possibly adjusted by a bias, a net input. The net input can then be provided to an activation function, which in turn provides a connected neuron 305 an output. The activation function can be a variety of suitable functions, typically selected based on empirical analysis. As illustrated by the arrows in FIG. 3, neuron 305 outputs can then be provided for inclusion in a set of inputs to one or more neurons 305 in a next layer.

As one example, the DNN 300 can be trained with ground truth data, i.e., data about a real-world condition or state. For example, the DNN 300 can be trained with ground truth data and/or updated with additional data by a processor of the remote server computer 150. Weights can be initialized by using a Gaussian distribution, for example, and a bias for each node 305 can be set to zero. Training the DNN 300 can include updating weights and biases via suitable techniques such as back-propagation with optimizations. Ground truth data can include, but is not limited to, data specifying objects, e.g., vehicles, pedestrians, etc., within an image or data specifying a physical parameter. For example, the ground truth data may be data representing objects and object labels. In another example, the ground truth data may be data representing an object, e.g., a vehicle, and a relative angle and/or speed of the object, e.g., the vehicle, with respect to another object, e.g., a pedestrian, another vehicle, etc.

During operation, the first computer 110 determines acceleration data and/or speed data for an identified vehicle 140, 215 (as discussed above) and provides the acceleration data and/or speed data to the DNN 300. The DNN 300 generates a prediction based on the received input. The output is a fuel consumption value for operating the host vehicle 105 in a same lane as the identified vehicle 140, 215. For example, when acceleration data and/or speed data for a lead vehicle 215 is input into the DNN 300, the DNN 300 outputs a first fuel consumption value for operating the host vehicle 105 in a first lane 205. As another example, when acceleration data and/or speed data for a target vehicle 140 is input into the DNN 300, the DNN 300 outputs a second fuel consumption value for operating the host vehicle 105 in a second lane 210.

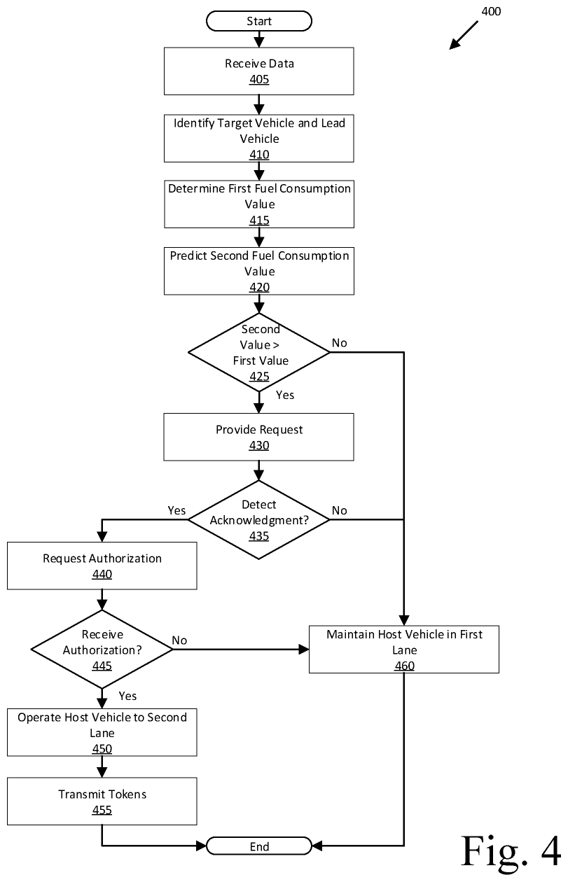

FIG. 4 is a diagram of an example process 400 for operating a host vehicle 105 in a first lane 205 of a road 200. The process 400 begins in a block 405. The process 400 can be carried out by a first computer 110 included in the host vehicle 105 executing program instructions stored in a memory thereof.

In the block 405, the first computer 110 receives data from one or more sensors 115, e.g., via a vehicle network, from a remote server computer 150, e.g., via a network 135, and/or from a computer in another vehicle, e.g., via V2V communications. For example, the first computer 110 can receive image data, e.g., from one or more image sensors 115. The image data may include data about the environment around the host vehicle 105, e.g., another vehicle operating on the road 200, such as a lead vehicle 215 operating in front of the host vehicle 105 in the first lane 205 and/or a target vehicle 140 operating in a second lane 210, lane markings, etc. The first computer 110 can then identify a first lane 205, i.e., a current lane of host vehicle 105 operation, based on the sensor 115 data, as discussed above. The process 400 continues in a block 410.

In the block 410, the first computer 110 identifies a vehicle operating on the road 200 as a lead vehicle 215 or a target vehicle 140. As set forth above, a lead vehicle 215 is a vehicle operating in the first lane 205 and forward of the host vehicle 105, and a target vehicle 140 is a vehicle operating in a second lane 210 and rearward of or next to the host vehicle 105. For example, the first computer 110 can identify a vehicle operating on the road 200 based on sensor 115 data, e.g., image data, as discussed above. Additionally, the first computer 110 can determine a lane of operation of the vehicle and a longitudinal position of the vehicle relative to the host vehicle 105 based on sensor 115 data, as discussed above. The first computer 110 can then identify the vehicle as a lead vehicle 215 or a target vehicle 140 based on the lane of operation of the vehicle and the longitudinal position of the vehicle relative to the host vehicle 105, as discussed above.

Additionally, or alternatively, upon identifying the vehicle via sensor 115 data, the first computer 110 can identify the vehicle as a target vehicle 140 based on acceleration data and/or speed data of the vehicle. For example, the first computer 110 can determine acceleration data and/or speed data of the vehicle based on sensor 115 data, as discussed above. Alternatively, the first computer 110 can receive the acceleration data and/or speed data from the vehicle, e.g., via V2V communications. As one example, the first computer 110 can compare an average speed of the vehicle to the average speed of the host vehicle 105 for a period of time. If the average speed of the vehicle is greater than or equal to the average speed of the host vehicle 105, the first computer 110 can identify the vehicle as a target vehicle 140. As another example, the first computer 110 can compare an average acceleration of the vehicle to a threshold acceleration (as discussed above). If the average acceleration of the vehicle is less than or equal to the threshold acceleration for the period of time, the first computer 110 can identify the vehicle as a target vehicle 140.

Additionally, or alternatively, the first computer 110 can identify the vehicle as a lead vehicle 215 or a target vehicle 140 based on clustered data. For example, the first computer 110 can cluster data, e.g., acceleration data, of the vehicle via a clustering algorithm, e.g., k-means clustering, as discussed above. The first computer 110 can then determine a centroid of a majority cluster, as discussed above, and compare the centroid to the threshold acceleration. When the centroid is greater than the threshold acceleration, the first computer 110 can identify the vehicle as a lead vehicle 215. When the centroid is less than or equal to the threshold acceleration, the first computer 110 can identify the vehicle as a target vehicle 140. The process 400 continues in a block 415.

In the block 415, the first computer 110 determines a first fuel consumption value for operating the host vehicle 105 in the first lane 205. For example, the first computer 110 can measure, e.g., via sensor 115 data, an amount of fuel consumed while operating in the first lane 205 and divide the amount of fuel consumed by the distance traveled in the first lane 205 while measuring the fuel consumption, as discussed above. As another example, the first computer 110 can input acceleration data and/or speed data for a lead vehicle 215 into a neural network, such as a DNN 300, that can be trained to accept acceleration data and/or speed data for a vehicle as input and generate an output identifying a fuel consumption value for operating the host vehicle 105 in a same lane as the vehicle, as discussed above. In such an example, the DNN 300 outputs the first fuel consumption value for operating the host vehicle 105 in the first lane 205. The process 400 continues in a block 420.

In the block 420, the first computer 110 predicts a second fuel consumption value for operating the host vehicle 105 in a second lane 210. For example, the first computer 110 can input acceleration data and/or speed data for a target vehicle 140 into the DNN 300. In such an example, the DNN 300 outputs a second fuel consumption value for operating the host vehicle 105 in a second lane 210. The process 400 continues in a block 425.

In the block 425, the first computer 110 determines whether the second fuel consumption value is greater than the first fuel consumption value. For example, the first computer 110 can compare the first fuel consumption value to the second fuel consumption value. As set forth above, a second fuel consumption value is “greater” than a first fuel consumption value when the second fuel consumption value is larger than the first fuel consumption value, e.g., 20 mpg is greater than 18 mpg. In the case that the second fuel consumption value is greater than the first fuel consumption value, the process 400 continues in a block 430. Otherwise, the process 400 continues in a block 460.

In the block 430, the first computer 110 provides, to the target vehicle 140, a request to move the host vehicle 105 from the first lane 205 to the second lane 210. For example, the first computer 110 can transmit the request to a second computer 145 included in the target vehicle 140, e.g., via V2V communications. As another example, the first computer 110 can actuate one or more host vehicle components 125 to output a signal indicating the request, as discussed above. In such an example, the first computer 110 may store a look-up table, e.g., in a memory, that correlates actuation of host vehicle components 125 to a request, as discussed above. For example, the first computer 110 may activate a turn signal, e.g., on the same side of the host vehicle 105 as the second lane 210. The process 400 continues in a block 435.

In the block 435, the first computer 110 determines whether an acknowledgement from the target vehicle 140 was detected. For example, the first computer 110 can receive, e.g., via V2V communications, a transmission from the second computer 145 indicating the acknowledgement. As another example, the first computer 110 can receive and analyze host vehicle sensor 115 data, e.g., image data, lidar data, etc., to detect the acknowledgement. For example, the first computer 110 can detect activation of one or more target vehicle 140 components via the host vehicle sensor 115 data, e.g., by using image processing techniques. In such an example, the first computer 110 can use a look-up table (as discussed above) to correlate the sensor 115 data to an acknowledgement. In the case that the acknowledgement is detected, the process 400 continues in a block 440. Otherwise, the process 400 continues in the block 460.

In the block 440, the first computer 110 requests authorization from the user to move the host vehicle 105 to the second lane 210. For example, the first computer 110 can actuate an HMI to output a message to a user requesting authorization to move the host vehicle 105 from the first lane 205 to the second lane 210. The first computer 110 may be programmed to receive user input from the HMI, as discussed above. The user may provide the user input via the HMI, e.g., by pressing a virtual button on a touchscreen display. The process 400 continues in a block 445.

In the block 445, the first computer 110 determines whether the user input indicates authorization to move the host vehicle 105 to the second lane 210. For example, the HMI may include sensors 115 to detect that a user selected a virtual button on the touchscreen display to authorize moving the host vehicle 105 from the first lane 205 to the second lane 210, which input can be received in the first computer 110 and used to determine the selection of the user input. The first computer 110 may be programmed to determine that the user does not authorize moving the host vehicle 105 to the second lane 210 when no user input is detected within a predetermined time, e.g., specified by a vehicle manufacturer, after the message is displayed via the HMI. In the case that the first computer 110 determines the user input authorized moving the host vehicle 105 from the first lane 205 to the second lane 210, the process 400 continues in a block 450. Otherwise, the process 400 continues in the block 460.

In the block 450, the first computer 110 operates the host vehicle 105 from the first lane 205 to the second lane 210. For example, the first computer 110 can actuate one or more host vehicle components 125 to move the host vehicle 105 from the first lane 205 to the second lane 210, e.g., in front of the target vehicle 140. The process 400 continues in a block 455.

In the block 455, the first computer 110 transmits tokens to the second computer 145. For example, the first computer 110 can determine a transfer rule, which specifies a number of tokens. For example, the transfer rule may be specified in one of the request or the acknowledgement, as discussed above. The first computer 110 may store a number of tokens, e.g., in a memory. The first computer 110 transmits the tokens to the second computer 145 upon operating the host vehicle 105 in the second lane 210. In this situation, the number of tokens stored in the memory of the first computer 110 decreases according to the transfer rule. Additionally, the number of tokens stored in a memory of the second computer 145 increases according to the transfer rule. The process 400 ends following the block 455.

In the block 460, the first computer 110 maintains the host vehicle 105 in the first lane 205. That is, the first computer 110 continues to operate the host vehicle 105 in the first lane 205. For example, the first computer 110 can actuate one or more host vehicle components 125 to operate the host vehicle 105 behind the lead vehicle 215. In this situation, the first computer 110 may be programmed to maintain a distance D between the host vehicle 105 and the lead vehicle 215 above a distance threshold. For example, the first computer 110 may adjust the speed and/or acceleration of the host vehicle 105 to maintain the distance D above the distance threshold. The process 400 ends following the block 460.

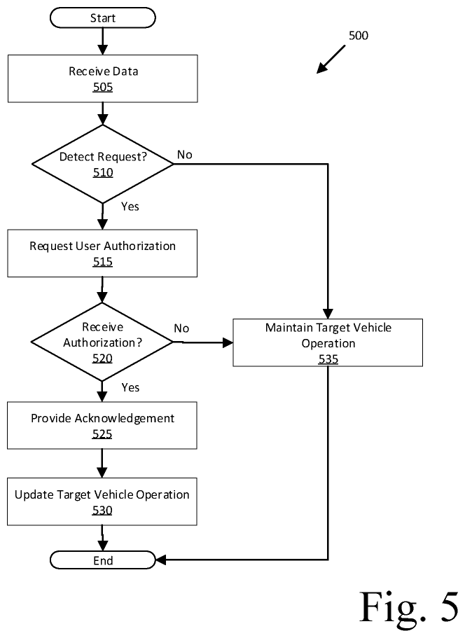

FIG. 5 is a diagram of an example process 500 for operating a target vehicle 140 in a second lane 210. The process 500 begins in a block 505. The process 500 can be carried out by the second computer 145 included in the target vehicle 140 executing program instructions stored in a memory thereof.

In the block 505, the second computer 145 receives data from one or more sensors 115, e.g., via a vehicle network, from a remote server computer 150, e.g., via a network 135, and/or from the first computer 110, e.g., via V2V communications. For example, the second computer 145 can receive image data, e.g., from one or more image sensors 115. The image data may include data about the environment around the target vehicle 140, e.g., another vehicle operating on the road 200, such as the host vehicle 105, lane markings, etc. The process 500 continues in a block 510.

In the block 510, the second computer 145 determines whether the request from the host vehicle 105 was detected. For example, the second computer 145 can receive, e.g., via V2V communications, a transmission from the first computer 110 indicating the request. As another example, the second computer 145 can receive and analyze target vehicle sensor 115 data, e.g., image data, lidar data, etc., to detect the request. For example, the second computer 145 can detect activation of one or more host vehicle components 125 via the target vehicle 140 sensor data, e.g., by using image processing techniques. In such an example, the second computer 145 may include a look-up table that correlates target vehicle sensor 115 data to a request, as discussed above. In the case that the request is detected, the process 500 continues in a block 515. Otherwise, the process 500 continues in a block 535.

In the block 515, the first computer 110 requests authorization from the user to acknowledge the request, i.e., accommodate the host vehicle 105 to move into the second lane 210. For example, the second computer 145 can actuate an HMI to output a message to a user of the target vehicle 140 requesting authorization to accommodate the host vehicle 105 to move into the second lane 210. The second computer 145 may be programmed to receive user input from the HMI. The user may provide the user input via the HMI, e.g., by pressing a virtual button on a touchscreen display. The process 500 continues in a block 520.

In the block 520, the second computer 145 determines whether the user input indicates authorization to accommodate the host vehicle 105 to move into the second lane 210. For example, the HMI may include sensors 115 to detect that a user pressed a virtual button on the touchscreen display to authorize accommodating the host vehicle 105 to move into the second lane 210, which input can be received in the second computer 145 and used to determine the selection of the user input. The second computer 145 may be programmed to determine the user does not authorize accommodating the host vehicle 105 to move into the second lane 210 when no user input is detected within a predetermined time, e.g., specified by a vehicle manufacturer based on, e.g., empirical testing of user response times, after the message is displayed via the HMI. In the case that the second computer 145 determines the user input authorized accommodating the host vehicle 105 to move into the second lane 210, the process 500 continues in a block 525. Otherwise, the process 500 continues in the block 535.

In the block 525, the second computer 145 provides, to the host vehicle 105, the acknowledgement. For example, the second computer 145 can transmit the acknowledgement to the first computer 110, e.g., via V2V communications. As another example, the second computer 145 can actuate one or more target vehicle 140 components to output a signal indicating the acknowledgment. In such an example, the second computer 145 may store a look-up table, e.g., in a memory, that correlates actuation of target vehicle 140 components to an acknowledgement, as discussed above. For example, the second computer 145 may flash headlamps, e.g., to indicate acknowledgement of the request. The process 500 continues in a block 530.

In the block 530, the second computer 145 updates target vehicle 140 operation. For example, the second computer 145 may actuate one or more target vehicle 140 components to maintain a distance Dₜ from the host vehicle 105 equal to or greater than the distance threshold. That is, the second computer 145 may actuate one or more target vehicle components to control the target vehicle 140, e.g., apply brakes, propel the target vehicle 140, etc., to maintain the distance Dₜ from the host vehicle 105 of at least the distance threshold. Additionally, the second computer 145 may be programmed to receive tokens from the first computer 110, as discussed above. The process 500 ends following the block 530.

In the block 535, the second computer 145 maintains the target vehicle 140 operation. That is, the second computer 145 continues to operate the target vehicle 140 in the second lane 210. For example, the second computer 145 may actuate one or more target vehicle 140 components to maintain the speed and/or acceleration of the target vehicle 140 in the second lane 210. The process 500 ends following the block 535.

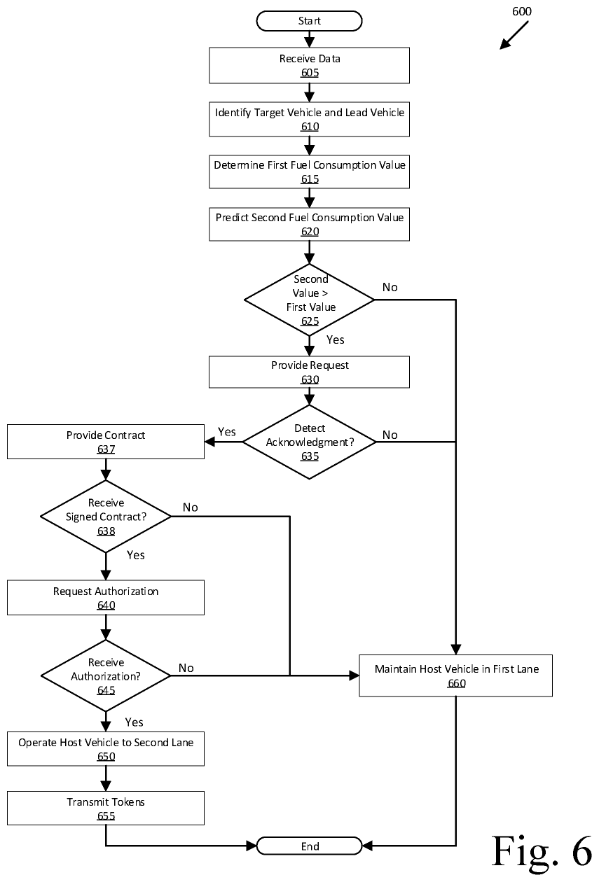

FIG. 6 is a diagram of another example process 600 for operating the host vehicle 105 in the first lane 205 of the road 200. The process 600 can be carried out by a first computer 110 included in the host vehicle 105 executing program instructions stored in a memory thereof. The process 600 includes blocks 605-635. The blocks 605-635 are substantially the same as blocks 405-435 of process 400 and therefore will not be described further to avoid redundancy.

Following the block 635, in a block 637, the first computer 110 provides a confirmation record to the second computer 145. For example, the first computer 110 can transmit the confirmation record to the second computer 145, e.g., via V2V communications. The confirmation record specifies that the target vehicle 140 accommodates the host vehicle 105 to operate in the second lane 210, as discussed above. The process 600 continues in a block 638.

In the block 638, the first computer 110 determines whether a validated confirmation record was received from the target vehicle 140. For example, the first computer 110 can receive, e.g., via V2V communications, a transmission from the second computer 145 including the validated confirmation record. In the case that the validated confirmation record was received, the process 600 continues in a block 640. Otherwise the process 600 continues in a block 660. The process 600 includes blocks 640-660. The blocks 640-660 are substantially the same as blocks 440-460 of process 400 and therefore will not be described further to avoid redundancy.

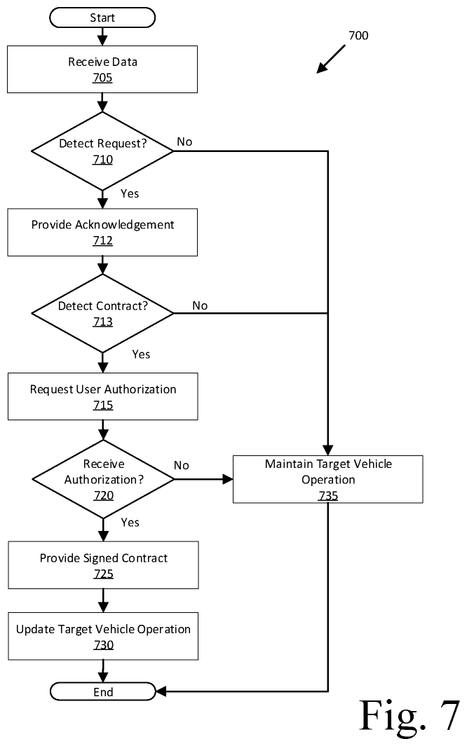

FIG. 7 is a diagram of another example process 700 for operating the target vehicle 140 in the second lane 210. The process 700 can be carried out by the second computer 145 included in the target vehicle 140 executing program instructions stored in a memory thereof. The process 700 includes blocks 705 and 710. The blocks 705 and 710 are substantially the same as blocks 505 and 510 of process 500 and therefore will not be described further to avoid redundancy.

Following the block 710, in a block 712, the second computer 145 provides, to the host vehicle 105, the acknowledgement. The block 712 is substantially the same as the block 525 and therefore will not be described further to avoid redundancy. The process 700 continues in a block 713.

In the block 713, the second computer 145 determines whether the confirmation record was received from the host vehicle 105. For example, the second computer 145 can receive, e.g., via V2V communications, a transmission from the first computer 110 including the confirmation record. In the case that the confirmation record was received, the process 700 continues in a block 715. Otherwise the process 700 continues in a block 735.

In the block 715, the second computer 145 requests authorization from a user of the target vehicle 140 to accept the confirmation record. The block 715 is substantially the same as the block 515 and therefore will not be described further to avoid redundancy. The process 700 continues in a block 720.

In the block 720, the second computer 145 determines whether the user input indicates authorization to accept the confirmation record. The block 720 is substantially the same as the block 520 and therefore will not be described further to avoid redundancy. In the case that the second computer 145 determines the user input authorized accepting the confirmation record, the process 700 continues in a block 725. Otherwise, the process 700 continues in the block 735.

In the block 725, the second computer 145 provides the validated confirmation record to the host vehicle 105. For example, the second computer 145 can transmit the validated confirmation record to the first computer 110, e.g., via V2V communications. The process 700 continues in a block 730.

The blocks 730 and 735 are substantially the same as blocks 530 and 535 of process 500 and therefore will not be described further to avoid redundancy.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a first computer including a processor and a memory, the memory storing instructions executable by the processor to:
determine a first fuel consumption value for operating a host vehicle in a first lane on a road surface;
predict a second fuel consumption value for operating the host vehicle in a second lane on the road surface based on acceleration data for a target vehicle operating in the second lane;
transmit, to the target vehicle, a request to move the host vehicle from the first lane into the second lane based on the predicted second fuel consumption value being greater than the first fuel consumption value; and
after receiving an acknowledgement from the target vehicle, operate the host vehicle from the first lane to the second lane.

2. The system of claim 1, wherein the instructions further include instructions to determine the first fuel consumption value based on acceleration data for a lead vehicle operating in the first lane in front of the host vehicle.

3. The system of claim 1, wherein instructions further include instructions to, upon receiving the acknowledgement, display a message in the host vehicle requesting a user input to authorize operating the host vehicle from the first lane to the second lane.

4. The system of claim 3, wherein the instructions further include instructions to operate the host vehicle from the first lane to the second lane based on receiving the user input in the host vehicle authorizing to operate the host vehicle from the first lane to the second lane.

5. The system of claim 1, wherein the instructions further include instructions to actuate a host vehicle component to output a signal indicating the request.

6. The system of claim 1, wherein the instructions further include instructions to detect the acknowledgement based on host vehicle sensor data.

7. The system of claim 1, wherein the instructions further include instructions to, upon operating the host vehicle in the second lane, provide a number of tokens to a second computer of the target vehicle based on a transfer rule.

8. The system of claim 7, wherein the instructions further include instructions to determine the transfer rule based on at least one of the request or the acknowledgement.

9. The system of claim 8, wherein the instructions further include instructions to, upon determining the transfer rule, operate the host vehicle from the first lane to the second lane based on receiving a user input in the host vehicle authorizing the transfer rule.

10. The system of claim 1, wherein the first computer is included on the host vehicle, the system further comprising a second computer on the target vehicle, the second computer including a second processor and a second memory, the second memory storing instructions executable by the second processor to:
after providing the acknowledgement, operate the target vehicle to maintain a distance between the host vehicle and the target vehicle greater than a distance threshold.

11. The system of claim 10, wherein the instructions further include instructions to actuate a target vehicle component to output a signal indicating the acknowledgement.

12. The system of claim 10, wherein the instructions further include instructions to detect the request based on target vehicle sensor data.

13. The system of claim 1, wherein the instructions further include instructions to input acceleration data for the target vehicle into a machine learning program that predicts the second fuel consumption value for operating the host vehicle in the second lane.

14. The system of claim 1, wherein the instructions further include instructions to identify the target vehicle based on an acceleration of the target vehicle being above a threshold acceleration for a time period.

15. The system of claim 14, wherein the instructions further include instructions to identify the target vehicle based further on a speed of the target vehicle being equal to or greater than a speed of the host vehicle for the time period.

16. A method, comprising:
determining a first fuel consumption value for operating a host vehicle in a first lane on a road surface;
predicting a second fuel consumption value for operating the host vehicle in a second lane on the road surface based on acceleration data for a target vehicle operating in the second lane;
transmitting, to the target vehicle, a request to move the host vehicle from the first lane into the second lane based on the predicted second fuel consumption value being greater than the first fuel consumption value; and
after receiving an acknowledgement from the target vehicle, operating the host vehicle from the first lane to the second lane.

17. The method of claim 16, further comprising identifying the target vehicle based on an acceleration of the target vehicle being above a threshold acceleration for a time period.

18. The method of claim 17, further comprising identifying the target vehicle based further on a speed of the target vehicle being equal to or greater than a speed of the host vehicle for the time period.

19. The method of claim 16, further comprising, upon receiving the acknowledgement, displaying a message in the host vehicle requesting a user input to authorize operating the host vehicle from the first lane to the second lane.

20. The method of claim 19, further comprising operating the host vehicle from the first lane to the second lane based on receiving the user input in the host vehicle authorizing to operate the host vehicle from the first lane to the second lane.
